(19) United States
(12) Patent Application Publication
(10) Pub. No.: US 2016/0275108 A1
(43) Pub. Date: Sep. 22, 2016

(54) Producing Multi-Author Animation and Multimedia Using Metadata

(71) Applicant: Jonathan Mark Sidener, Drexel Hill, PA (US)

(72) Inventor: Jonathan Mark Sidener, Drexel Hill, PA (US)

(21) Appl. No.: 15/019,659

(22) Filed: Feb. 9, 2016

Related U.S. Application Data
(60) Provisional application No. 62/113,878, filed on Feb. 9, 2015.

(51) Int. Cl. G06F 17/30; H04N 5/77; H04N 5/265; H04N 1/21; H04N 5/232; G06T 13/80; H04L 29/06; H04N 5/247

(52) U.S. Cl. CPC G06F 17/30268; H04L 67/42; H04N 5/77; H04N 5/247; H04N 1/2187; H04N 5/23216; G06T 13/80; H04N 5/265

(57) ABSTRACT

The present invention relates to the creation of digital multimedia, in particular the creation of digital animation and or audio tracks by multiple participants. Specifically, the invention relates to a novel method to facilitate, through automation, custom tools and custom methods, the creation and maintenance of a collaboration of two or more individuals who generate incremental media elements, and a resultant accretive animation and or audio thereof. The invention in some embodiments creates a set of collaborative tools that allow multiple users to contribute incremental media elements such as but not limited to still images, audio clips, editing effects such as filters, metadata, captions and comments to a shared project pool; that provide automatic or semi-automatic rendering to transform the incremental elements into an aggregate or accretive media product such as an animation and/or audio track and returns the resultant animation and or audio in various configurations based on variables such as time stamps, source and user-generated tags to participants and/or designated repositories, including but not limited to a website centered around the collaborative media produced by the tools and various social networking sites and tools.

### CROSS REFERENCE TO RELATED APPLICATIONS

Provisional application No. 62/113,878 filed Feb. 9, 2015

### FEDERALLY SPONSORED RESEARCH

Nonapplicable

### SEQUENCE LISTING OR PROGRAM

Nonapplicable

### BACKGROUND OF THE INVENTION

Animation traditionally has been defined as a process of creating the illusion of motion and shape change by the rapid display of a sequence of static images called frames that minimally differ from each other.

Yet almost from the beginning of cinematography there has been an undercurrent of non-literal storytelling within animation and cinema. In the late 1800s the French magician turned film maker Georges Melies, Thomas Edison and others experimented with stop-motion, fast forwarding, slow motion and other early special effects using the developing technology. These early effects were soon followed by techniques such as the presentation of random images as collages and montages.

Fast forward to modern times and you will find non-literal, highly stylized GIF animations hold enduring popularity and are often shared on social networks. Yet despite their popularity on social media, such animations invariably produced by solitary individuals, or perhaps as an exception to the rule, by two or three people huddled around a single computer. They are generally characterized by stop-motion and stop-motion-like effects, or a small number of frames taken out of context and presented in a loop to emphasize a quirky or humorous movement or to highlight a defining moment in a sporting contest or drama.

Despite the term “new media” today's social networks adhere to the age-old model of a performer/writer published to a wider audience. In today's social media, one person creates and later the audience is allowed to comment.

There have been some attempts to make this process collaborative, with editors taking turns, in a process comparable to multiple individuals making contributions to a single Wikipedia page. The resulting process is cumbersome and primarily manual. Online role-playing and action games allow players to record in-game action, but the resulting video is limited to the confines of the on-screen world.

### SUMMARY OF THE INVENTION

The present invention creates a novel set of tools that allow multiple authors to simultaneously document a real world event by allowing users to contribute incremental media elements such as still images, audio clips and editing effects such as filters, captions and comments to a shared project pool; that provide automatic or semi-automatic rendering of an aggregate media product such as an animation and/or audio track from the incremental elements; and returns animation that can be published, shared or displayed.

Rather than the traditional production of a multimedia product from the creative direction of one, or a few concerted creative minds and published to many, the invention turns the process around and empowers any and all participants to become creative forces and participate from beginning to end in a fully social experience.

More specifically, the invention uses a set of interrelated software modules some of which may be installed and run on individual electronic devices controlled by participants in the collaboration. Other software modules run on one or more servers or computing devices and store, process and distribute media generated by the collaboration. Collectively and individually, the software modules are referred to here as the app and the tools.

In one embodiment some of these tools allow and facilitates the creation of a defined collaborative network of multiple users generally centered around a particular event or common element and therefore generally characterized by set start and end points. These collaborative networks may be brief or lengthy, singular or recurring. The collaboration may be established to document a small social outing—a golf foursome, for example—without any expectation of great cultural substance or meaning, or it might be established with grandiose artistic design—a million collaborators documenting random acts of kindness around the world on a given day or week, for example.

Participants download portions of the app onto remote computerized devices—for example smartphones, tablets, personal computers and wearable devices such as smart watches—and use the app's User Interface for several preliminary functions including, inviting participants, accepting invitations, determining tags to be used during the collaboration and to communicate with fellow participants through text and voice messages.

The tools include the ability to restrict membership in a collaboration strictly, with the First User determining who can participate; less strictly, with any participant having permission to invite others; and without minimal restriction, opening a collaboration to anyone who chooses to join.

Some or all members of the collaborative network record the event or common element using digital cameras and/or microphones such as those found on smart phones and tablet computers or use alternative methods of securing and transmitting images and or audio—for example clip art, digital drawings or music on a computer.

Once the start point is reached, participants can use the app's UI to operate the smartphones camera and microphones to generate media elements and tag the elements to create metadata that can be used to customize the organization and display of the aggregated animation and audio. The elements include static images, short series of static images such as stop-motion video and short video clips. Participants can use the UI to edit the incremental files, for example to write captions using the keypad or alternative input methods for photos, or add filters, frames or other effects before sending the file to the collaboration. As part of submitting the file to the collaboration, the app will store metadata in the image file name and or using Exif or any of several other available metadata schema.

These generating devices used in a collaboration are capable of sending and receiving incremental elements and other digital files via a digital network and are capable of loading, storing and running the app.

The recorded incremental media elements are uploaded to a pool, such as a server with retrievable memory. Software on the server and or on the network members smart phones and other devices renders animation or audio tracks by converting the still images into frames and audio clips into an aggregate sound track using default or custom parameters. The software makes available to collaborative network members downloadable or streamable copies of the aggregated product.

### THE DRAWINGS

FIG. 1 provides an overview of a collaborative event and the resultant collaborative animation file.

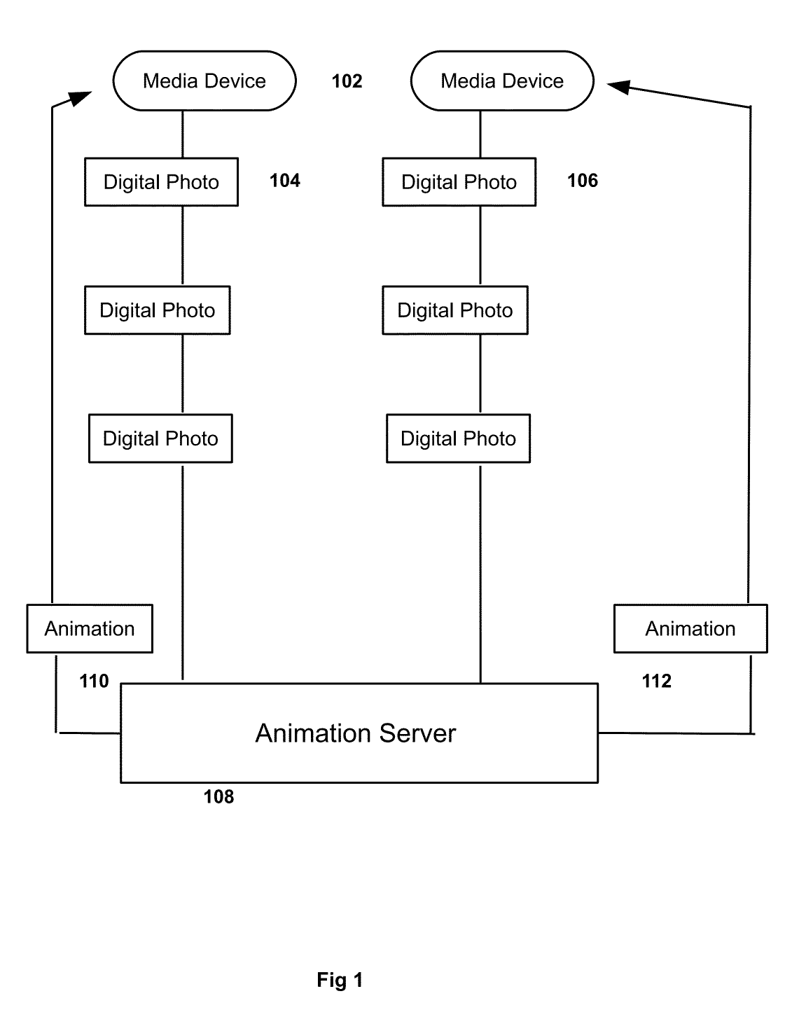

FIG. 2 shows a collaborative animation with advanced metadata.

FIG. 3 shows the invitation process and resulting exclusivity of a collaborative event.

FIG. 4 shows the user interface and process for user-generated metadata.

FIG. 5 shows a collaboration rendered according to a default criteria.

FIG. 6 shows a collaboration rendered according to a user-defined criteria.

FIG. 7 shows the creation of a metadata file and the database in an animation server.

FIG. 8 shows a UI for incremental and decremental time-lapse image series.

FIG. 9 show the addition of audio elements to a collaboration.

FIG. 10 shows an example mobile device including hardware architecture and installed applications.

FIG. 11 shows an example of software architecture on a mobile device.

FIG. 12 shows a UI for adding metadata tags, comments and captions.

### DETAILED DESCRIPTION

In the following detailed description of the invention, several features, examples and embodiments of the invention are set forth and described. However, the invention is not limited to the embodiments set forth and it may be practiced without some of the specific details and examples discussed.

Some embodiments described here create a collaborative graphics method and related tools that allow two or more people to operating two or more media devices 102 to participate in a shared animation or multimedia project by recording and otherwise collecting incremental audio and or visual media elements such as digital photographs 104, then contributing the incremental elements to the project, hereinafter referred to as a collaboration; it includes the movement and storage of the incremental elements, which in this example are digital photographs; and it includes a related animation server 106 capable of cropping, re-sizing and converting the images from multiple authors into animation frames and rendered in a format such as, but not limited to animated GIFs or MPEG4 or WMV video 108 and 110.

This embodiment uses basic metadata, such as the order of the image files as stored on the server to determine the order of the frames, which effects an approximation of chronological ordering.

The embodiment includes a software app (hereinafter the app) downloaded and installed on a network capable device containing a processor, memory, a camera or other means to generate images, a hardware keyboard or software user input system such as a touch screen, with common examples of these devices being smartphones and tablets. For ease of description, these devices will be referred to hereinafter as mobile devices, although this is not a binding limitation of this or other conceivable embodiments.

The embodiment includes software uploaded to and running on at least one network server which has at least one processor and memory. The server and app are able to exchange data using the network.

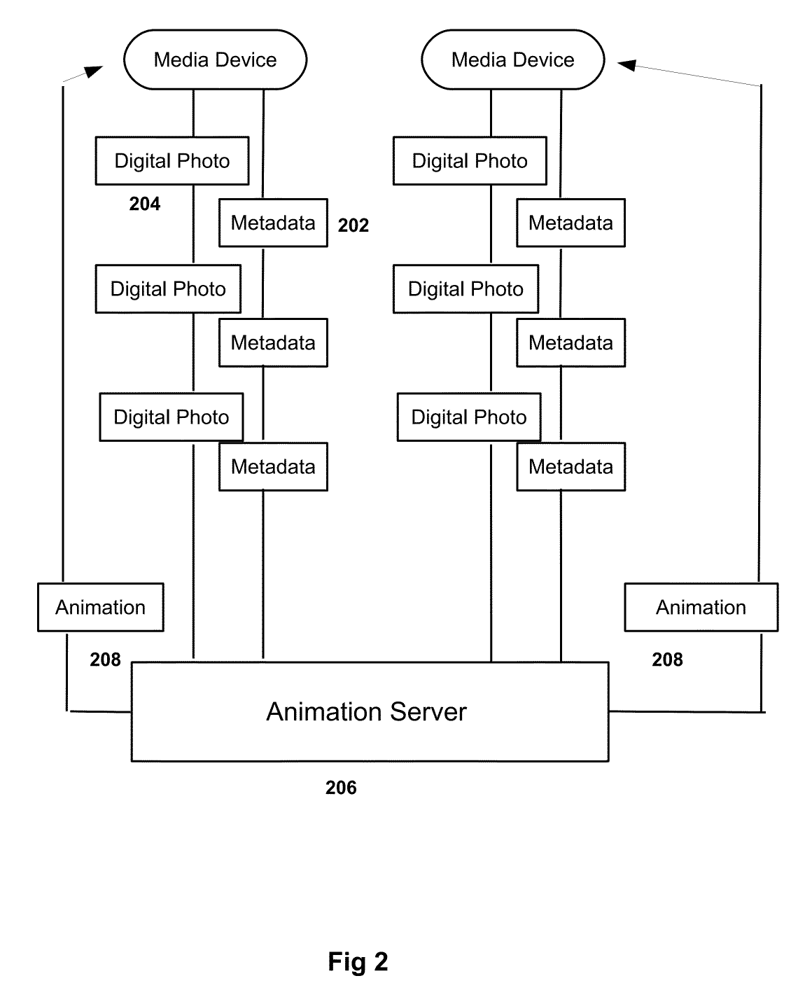

Alternately, an embodiment could use a more robust metadata system, using the mobile devices to generate metadata and incorporating an organizational system that facilitates structured storage and management of the photos and associated metadata as seen in FIG. 2. The embodiment uses auxillary components on the mobile device, for example a clock or GPS receiver, to generate metadata 202 associated with each image 204. The photos and metadata are uploaded to an animation server 206 which includes file storage for the images and a database for managing and sorting the metadata.

The animation server sorts the metadata using a default criteria, in this example time stamp metadata, orders the images as frames in an animation, which is then returned to collaborators 208.

To facilitate multiple participants in a meaningful collaboration, the embodiment contains a system of inclusion and exclusion rules analogous to chat and VOIP conference call systems offered by many top technology companies. At the broadest level of inclusion/exclusion, users must download and install the app and register a user account.

This first step of inclusion requires one or more user-interface (UI) screens on the mobile device. Each user is required by the interface to provide a valid email address and to select a unique user name and password. The app uploads to the server a user record containing the input responses, along with identifying features of the mobile device such as an IMEI or IMSI. The password may optionally be stored on the mobile device so that it need not be keyed in each time the app is launched.

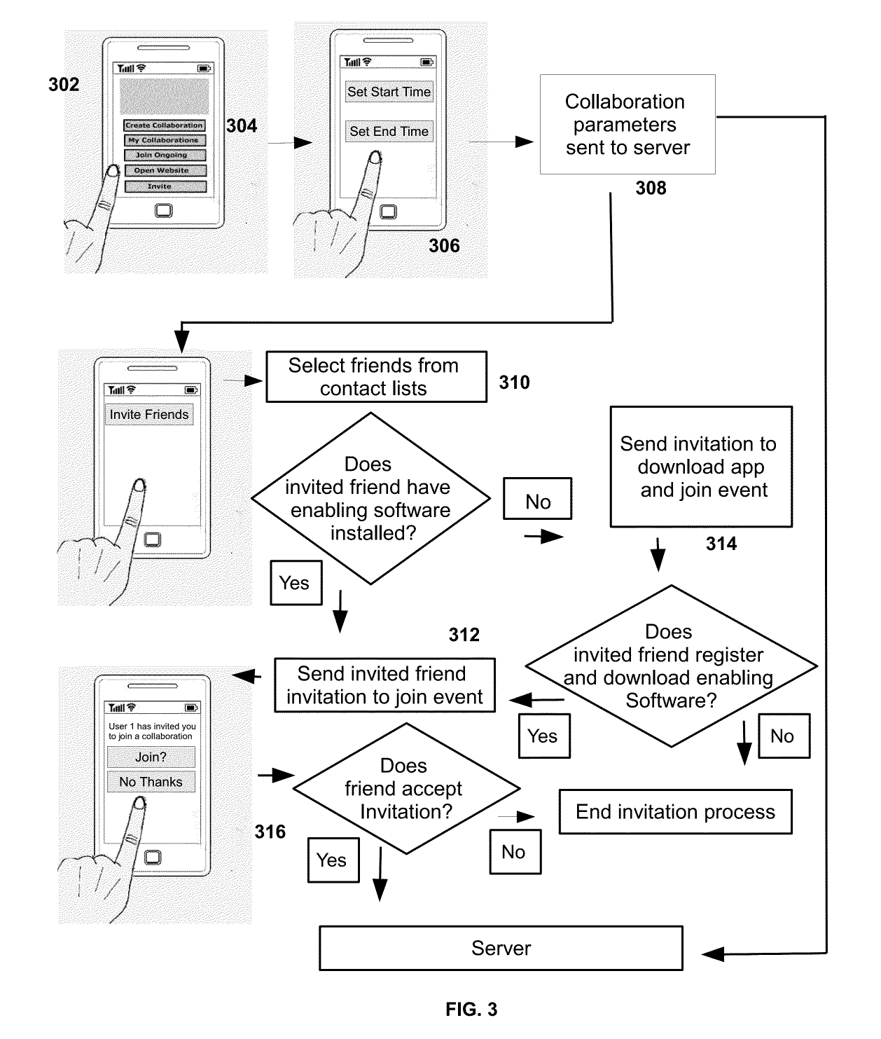

Once a user has registered or logged in, the app will display the home screen on the mobile device. As seen in FIG. 3, the home screen 302 includes a display area and navigation buttons to components of the app. The first 304 takes a member to a second screen 306 where he can create a collaboration by defining parameters such as start time and end. Parameter data input into the UI is uploaded 308 to the server along with the ID of the first user, who becomes the first included user of the collaboration.

With parameters uploaded, the app then opens the next UI screen, which prompts the first user to invite others to the collaboration. When the Invite Friends button is clicked, the app presents the first user with lists of contacts, including phone contacts, email contacts and social media contacts. 310

If an invited friend is a registered user, the app sends an invitation 312. If the invited friend does not have the app installed, he or she receives an invitation to download the app 314. If the invited friend downloads and installs the app, the friend receives an invitation to join the collaboration. 312

If the invited friend joins the collaboration, the response is relayed to the server 314 where the invited friend's User ID is added to the list of included users.

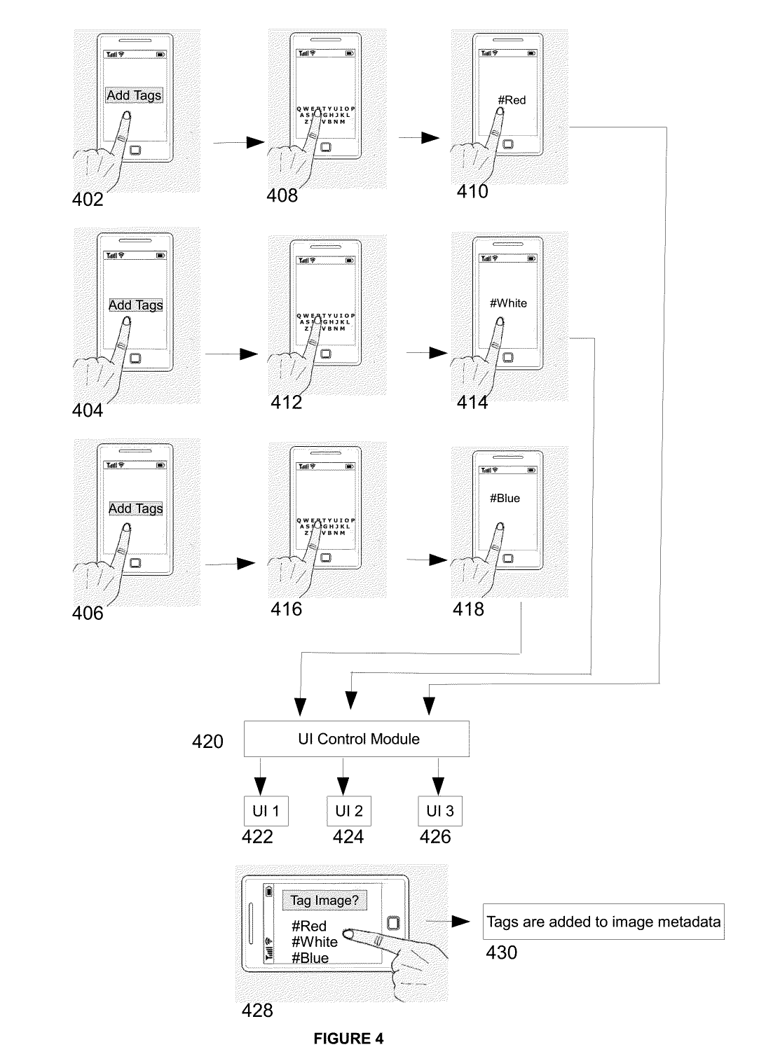

In some embodiments, the app presents the option for collaborators to contribute tags for the collaboration, either in advance or during the collaboration. In FIG. 4 for example, the create tags UI screen is separately presented to three collaborators 402, 404 and 406 showing on-screen buttons to contribute tags. The first uses a keypad 408 to type in the tag #Red 410. The second uses her keypad 412 to add the tag #White 414. The third uses a keypad 416 to enter the tag #Blue 418. The tags are sent to a UI Control Module 420 on one of the one or more servers, which distributes copies of the tags to all of the tag UI of the mobile devices included in the collaboration 422, 424 and 426. During the collaboration, after any of the three takes a picture, the UI will present the option of adding the three user-generated tags to the image's metadata with a single tap of the screen, eliminating the need to re-key the tags. When tapped the UI adds a tag to the picture's metadata 430. Other embodiments could use other input methods including, but not limited to, handwriting recognition technology using characters drawn on the touch screen, speech-recognition technology, and gesture-recognition technology.

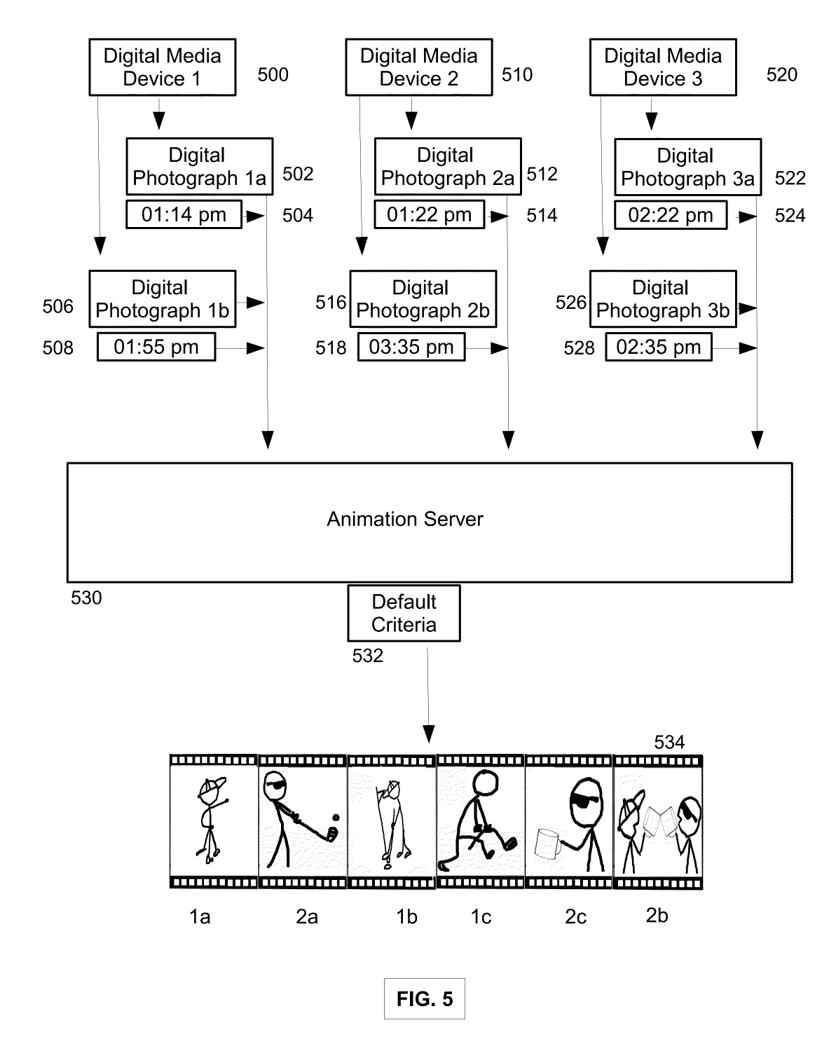

Some embodiments may include a means for recording metadata as one or more small strings separate from, but linked to a larger file that holds the main data of the image or audio recording. In the example embodiment illustrated in FIG. 5, the time stamps of six photos are recorded in this manner and then uploaded to a server. In other embodiments, the metadata may be incorporated and uploaded with the main data using systems such as Exif or it may be aggregated in the file name to be read or decoded later.

In this embodiment, the first mobile device 500 records a first photograph 502 with a time stamp recorded at 1:14 pm and stored as a string 504. For sake of illustration and brevity, seconds and fractions of seconds are not shown.

This first device records a second photograph 506 with a time stamp 508 recorded at 1:55 p.m.

A second mobile device 510 records a first photograph 512 with a time stamp recorded at 1:22 pm and stored as a string 514. The second device records a second photograph 516 with a time stamp 518 recorded at 3:35 p.m.

A third mobile device 520 records a first photograph 522 with a time stamp recorded at 2:22 pm and stored as a string 524. The second device records a second photograph 526 with a time stamp 528 recorded at 2:35 p.m.

The images are uploaded to an animation server, 530, along with the metadata and an identifier that links the metadata to the image, which are moved to a database within the animation server. The metadata from each image makes up a single record in the database, so in this example there would be six records, each containing three fields: a sequential record ID assigned by the database, a time stamp and an ID that links to the photo.

The animation server sorts the metadata using a default criteria 532 which in this example is chronological order. The animation server uses the sorted metadata to correspondingly order the digital photos as frames in an animation 534.

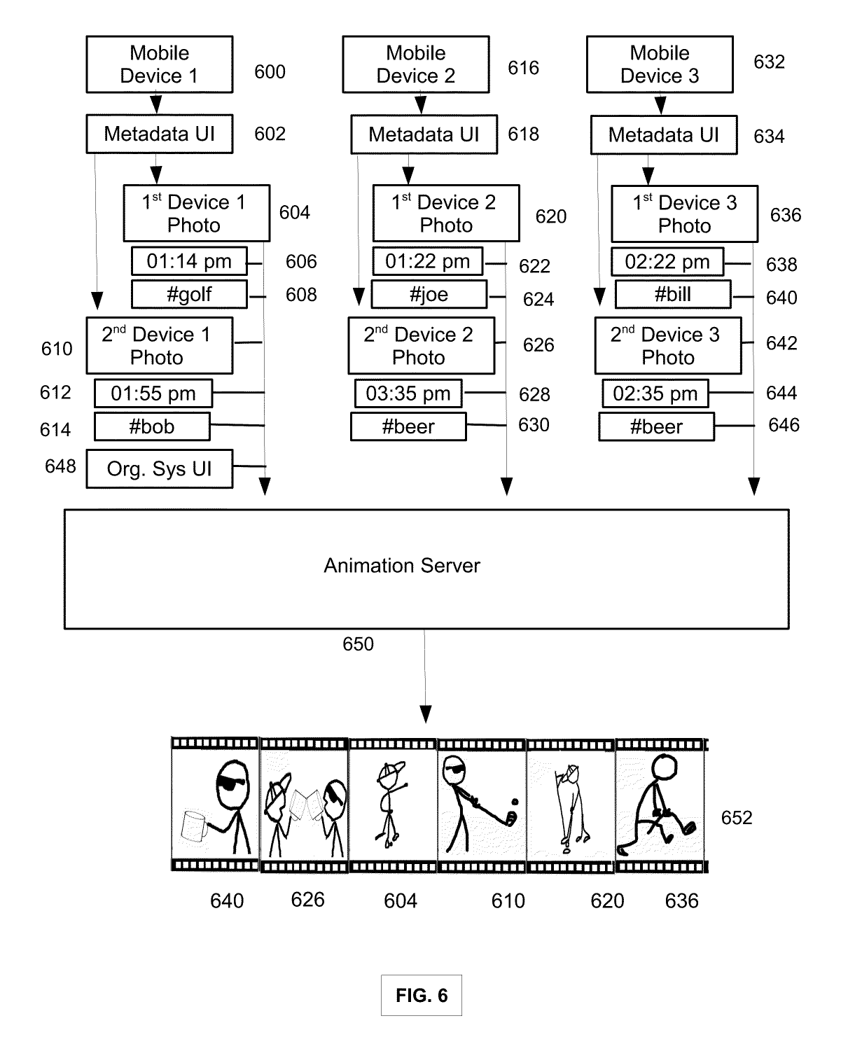

In an alternate embodiment shown in FIG. 6, collaborators have the option of adding metadata tags as detailed above in FIG. 4. A first user takes a photo 604 using mobile device 1 600. The app records a time stamp of 1:14 pm. 606. The first user then uses the metadata UI 602 to add the tag #golf 608.

The first user takes a second photo 610 which receives a time stamp of 1:55 pm 612. He then adds the tag #bob 614 to the second photo.

A second user takes a photo 620 using mobile device 2 616. The app records a time stamp of 1:22 pm. 622. The second user then uses the metadata UI 618 to add the tag #joe 624. The second user takes a second photo 626 which receives a time stamp of 3:35 pm 628. He then adds the tag #beer 630 to the second photo.

A third user takes a photo 636 using mobile device 2 632. The app records a time stamp of 2:22 pm. 638. The third user then uses the metadata UI 634 to add the tag #bill 640. The third user takes a second photo 642 which receives a time stamp of 2:35 pm 644. He then adds the tag #beer 646 to the second photo.

The photos and metadata are uploaded as detailed above in FIG. 5. User 1 then opens an organizational system UI screen to change the criteria used to sort the metadata and associated images. He selects the tag #beer.

The animation server sorts the metadata, prioritizing the two files tagged #beer and then using the default criteria for the remaining files. The animation server 650 uses the sorted metadata to correspondingly order the digital photos as frames in an animation 652 with the two photos tagged #beer as the first two frames.

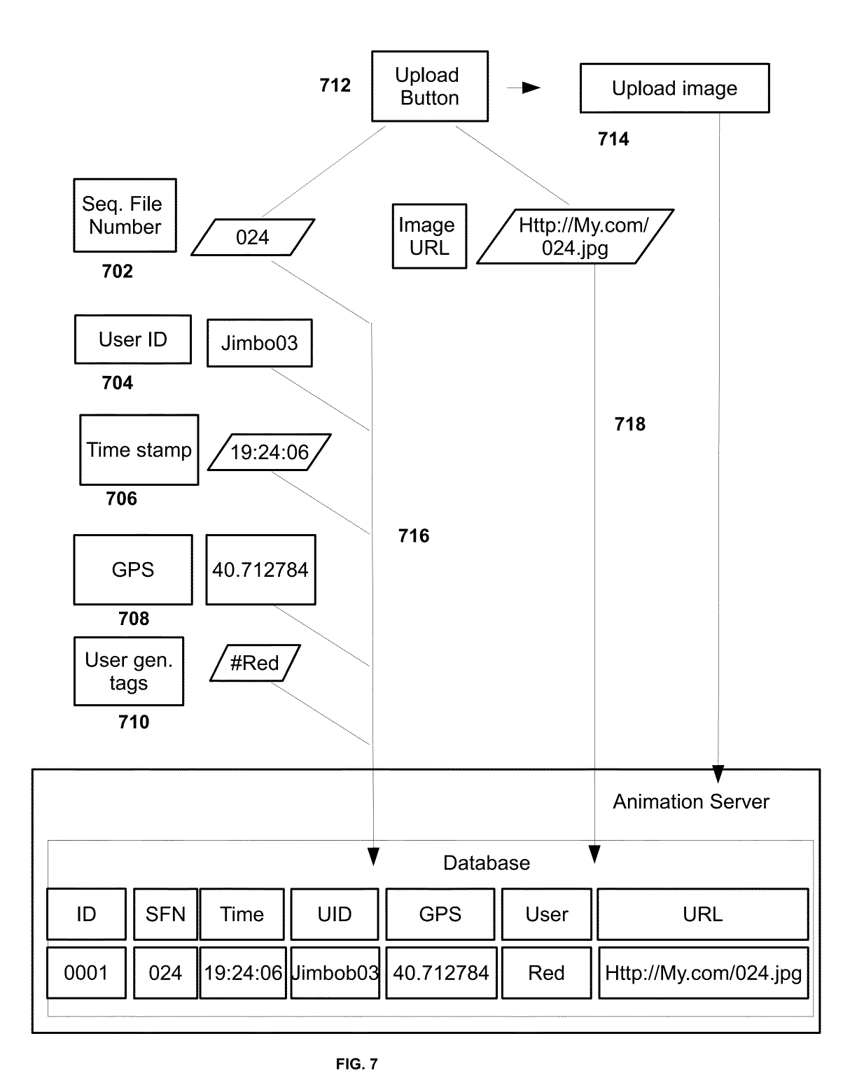

In FIG. 7 a detailed view of metadata creation and management can be seen. After the app presents a user with the option of adding metadata to a photo, the UI will present an additional option of uploading the image to the collaboration. At this point, there are several categories of potential metadata available to be uploaded with the image. When the image is recorded, the app creates a sequential file number 702 using rules to prevent multiple cameras in any single collaboration from creating identical file numbers, which would create a collision or conflict in the database.

The app also has access to the user ID of each of the collaboration participants 704. Information from auxillary components such as time from a clock 706, location 708 from GPS and user-generated tags are all available as potential metadata.

In this example, the user adds the tag #red 710 and then clicks the Upload button 712 in the UI.

This uploads the image to the animation server 714 where it is stored as a file. The click also instructs the app to get the metadata strings 716 and to upload the strings to the corresponding record and fields in the database. The URL for the uploaded file is similarly recorded as a string and 718 uploaded to the same record.

In order to create stop motion effects in collaborations, the app provides functions to shoot short sequences of images. The UI in one embodiment for example provides three shutter function buttons, one to shoot single frames, a second to shoot a sequence and a third to shoot a rapid sequence.

The app will use a metadata scheme to keep the series of images together when the animation is rendered, for example time stamps information for each of the images in a time lapse series may be written to show the time stamp of the first image so that if a first user shoots three images A, B and C in a time span beginning at 01:00.01 a.m., with image B shot at 1:00.02 a.m. and image C shot at 1:00.03 a.m. and a second user shoots image D during that time span, 1:00.02 for example, images A, B and C will be rendered according to the time stamp of 1:00.01 a.m. And image D will be rendered as the following frame.

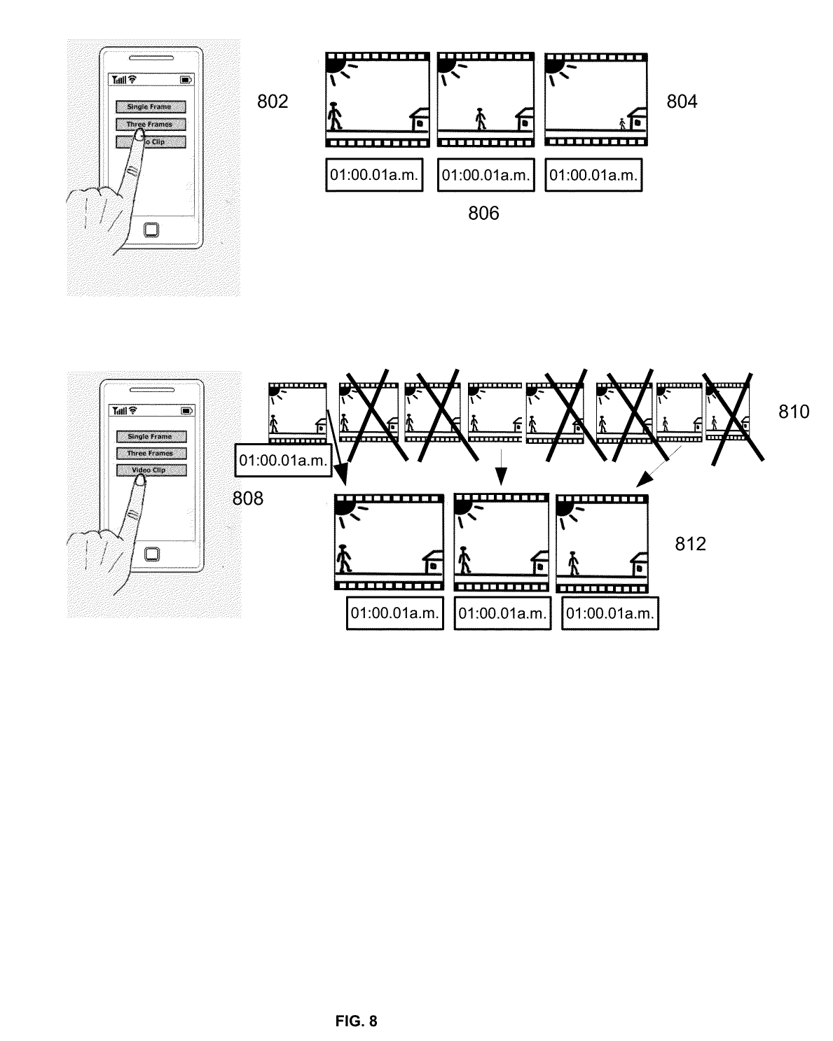

In FIG. 8, the UI 802 presents three ways to shoot images for a collaboration, single frame, three pictures or short video.

Pressing the Three Frames button results in a short series of images 804, with each of the three receiving identical time stamps, and so the three will be rendered as an uninterrupted series by disregarding the true timestamps of the second and third images.

Selecting the Video Clip button 808 will result in a similar, but not identical result of three images. In this embodiment, the app will use the camera to shoot a brief series of video frames 810, which records eight frames. The app retains one of every three frames and drops the other two, so in this example three are retained and five are discarded, which creates a time lapse shorter than that described above. The retained three frames 812 receive identical time stamps as in the previous example.

Incremental media can include audio clips as well as images. While animation requires that images be displayed at a rate of more than one per second, brief audio clips will often be longer than one second, so audio and image elements cannot be paired one-to-one. In some embodiments, audio can be added to the animation as a separate track. The number of audio elements would typically be proportionally less than the number of image frames.

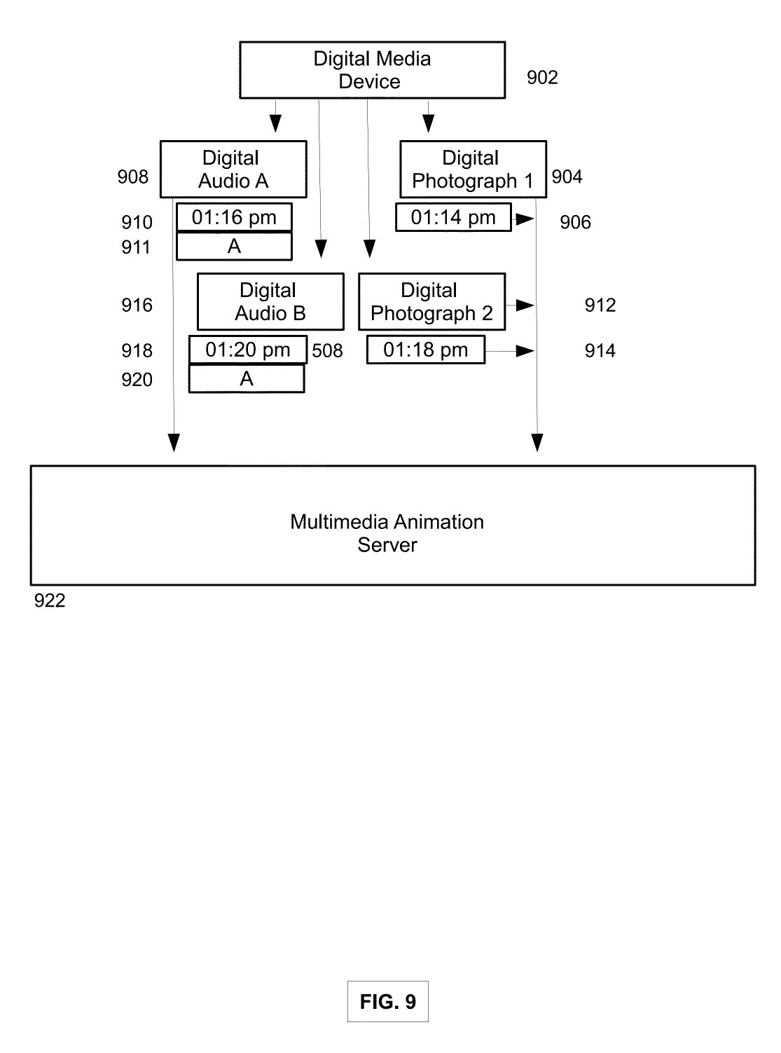

FIG. 9 shows the addition of audio to a collaboration as a parallel track. Using a digital media device 902, a collaborator records a photograph 904, which receives a time stamp 906 of 01:14 pm. The collaborator then records a brief audio clip 908 which receives a time stamp 910 of 01:16 p.m.

The audio clip then receives a second metadata element 911 marking the media type as A.

The collaborator then takes a second picture 912, which receives a time stamp 914 of 01:18 p.m. The collaborator then records a second brief audio clip 916, which receives a time stamp 918 of 01:20 p.m and a second metadata element 920 marking the data type as A.

The pictures and audio clips are moved to a multimedia server, which has at least one database and the ability to render animation from the photographs as well as the ability to compile the audio clips into an audio track added to the animation.

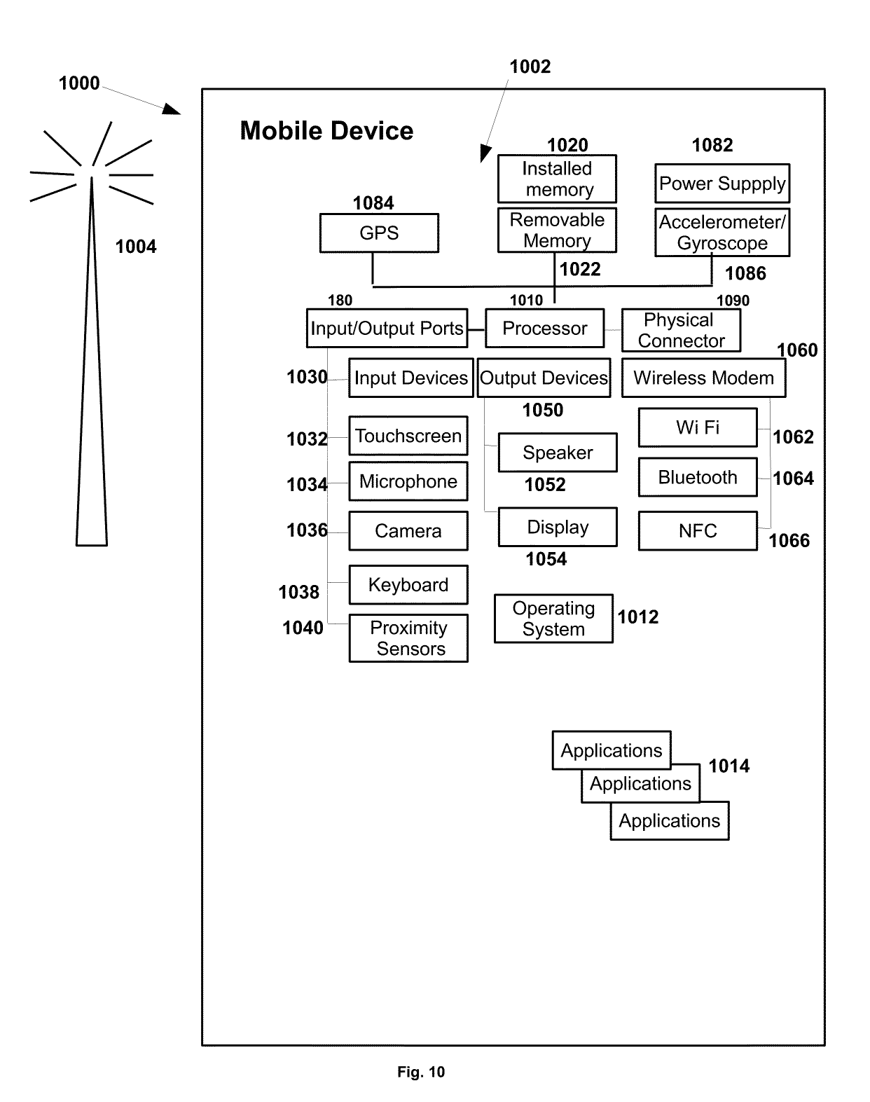

FIG. 10 is a system diagram of an example mobile device 1000 including an optional variety of hardware and software components, shown generally at 1002. Any components 1002 in the mobile device can communicate with any other component, although not all connections are shown, for ease of illustration. The mobile device can be any of a variety of computing devices (e.g., cell phone, smartphone, notebook computer, tablet, etc.) and can allow wired or wireless two-way communications with one or more communications networks 1004, such as a cellular network, Local Area Network or Wireless Local Area Network, Personal Area Network, Ad Hoc Networks between multiple devices etc.

The illustrated mobile device 1000 can include a controller or processor 1010 including but not limited to a signal processor, microprocessor, ASIC, or other control and processing logic circuitry for performing such tasks as signal coding, data processing, input/output processing, power control, and/or other functions. An operating system 1012 can control the allocation and usage of the components 1002, including the camera, microphone, touch screen, speakers and other input and output devices and applications 1014. The application programs can include common mobile computing applications (e.g., image-capture applications, image editing applications, video capture applications, email applications, contact managers, web browsers, messaging applications), or any other computing application.

The illustrated mobile device 1000 can include memory such as non-removable memory 1020 and/or removable memory 1022. The non-removable memory 1020 can include RAM, ROM, flash memory, a hard disk, or other well-known memory storage technologies. The removable memory 1022 can include flash memory or a Subscriber Identity Module (SIM) card, which is well known in GSM communication systems, or other well-known memory storage technologies, such as “smart cards” including USB memory devices. The memory can be used for storing data and/or code for running the operating system 1012 and the application programs 1014. Example data can include web pages, text, images, sound files, video data, or other data sets to be sent to and/or received from one or more network servers or other devices (including input devices 1030 such as cameras, microphones and keyboards) via one or more wired or wireless networks. The memory can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment and can be attached to or associated with stored incremental media elements to identify their sources.

The mobile device 1000 can support one or more input devices 1030, such as a touch screen 1032, microphone 1034, camera 1036, physical keyboard 1038, and/or proximity sensor 1040, and one or more output devices 1050, such as a speaker 1052 and one or more displays 1054. Other possible output devices (not shown) can include piezoelectric or haptic output devices. Some devices can serve more than one input/output function. For example, touch screen 1032 and display 1054 can be combined into a single input/output device.

A wireless modem 1060 can be coupled to an antenna (not shown) and can support two-way communications between the processor 1010 and external devices, as is well understood in the art. The modem 1060 is shown generically and can include a cellular modem for communicating with the mobile communication network 1004 and/or other radio-based modems (e.g., Bluetooth 1064 or Wi-Fi 1062 NFC 1066). The wireless modem 160 is typically configured for communication with one or more cellular networks, such as a GSM network for data and voice communications within a single cellular network, between cellular networks, or between the mobile device and a public switched telephone network (PSTN).

The mobile device can further include at least one input/output port 1080, a power supply 1082, a satellite navigation system receiver 1084, such as a Global Positioning System (GPS) receiver, an accelerometer 1086, a gyroscope, and/or a physical connector 1090, which can be a USB port, IEEE 1394 (FireWire) port, and/or RS-232 port. The illustrated components 1002 are not required or all-inclusive, as any components can be deleted and other components can be added.

### Software Architecture

In some embodiments, the processes described above are implemented as software running on a particular machine, such as a computer or a hand held device, or stored in a machine readable medium.

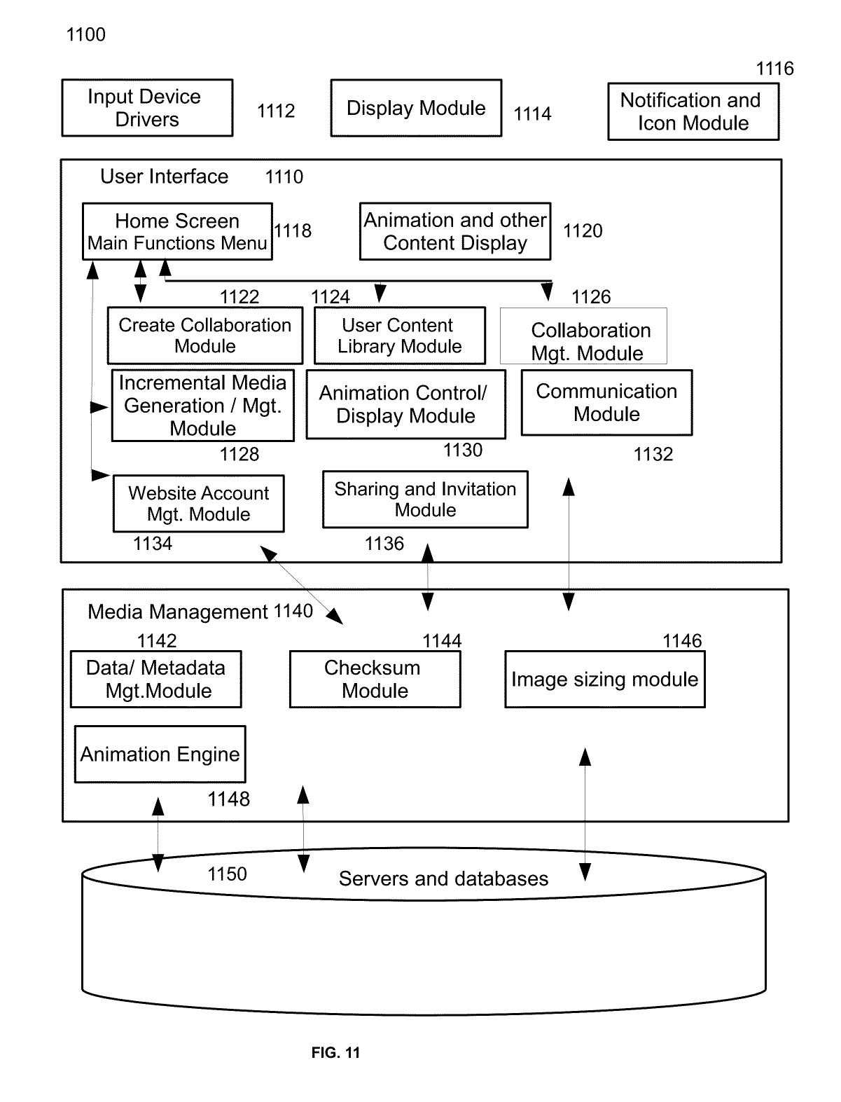

FIG. 11 conceptually illustrates the software architecture of collaborative animation tools 1100 of some embodiments.

In some embodiments, the collaborative animation tools are provided as an installed stand-alone application running primarily or completely on the remote devices enabling the collaboration. While in other embodiments the collaborative animation tools run primarily as a server based system. In a third category of embodiments, the collaborative animation tools are provided through a combination of server-side and device-installed software and other forms of machine readable code, including configurations where some of all of the tools are distributed from servers to client devices.

The collaborative animation tools 1100 include a user interface (UI) module 1110 that generates various screens through its Display Module 1114 which provide collaborators with numerous ways to perform different sets of operations and functionalities and often multiple ways to perform a single operation or function. Among its functions, the UI's display screen presents an actionable target and menu of options to control the tools through interactions such as touch and cursor commands. In addition, gesture, speech and other input methods of human/machine interaction, use associated software drivers 1112 of input devices such as but not limited to a touch screen, mouse, microphone and or camera; and the UI responds to that input to alter the display and allow a user to navigate the UI hierarchy of screens and ultimately to allows the user to provide input/control of the various software modules that make up the tools. Interaction with the tools is often initiated through contact with the notification and icon module 1116 and associated points of entry generated by the notification and icon module and displayed the UI. These include audible, visual and haptic notifications, including status bar alerts that appear on a mobile device home screen or computer screen system tray or similar area or are sounded when alerts are received about app-related activity whether or not the app is open and includes an icon to launch the app from the main app menu, a computer desktop screen, from start screens or any other location where devices allow placement of icons.

The UI includes a main screen. The UI main screen includes a menu of main app 1118 functions that correspond and link to the app's main functions (tools) such as but not limited to the creation of a collaboration; providing access to a personalized user library screen of past, ongoing, scheduled and bookmarked collaborations; entrance to ongoing collaborations; a link to a related website of collaborations and discussions; and a function to invite other users to register for and download the app.

It also includes a display area 1120 controlled by the UI and related modules where may be displayed previous or ongoing collaborations, in-app messages from collaborators or other users, system-generated communication including advertising sent to the device's display module

Navigation of the UI takes users to a second tier of screens with controls for specific functions for each tool, for example the Create Collaboration button in the Main Menu screen takes the user to the Create Collaboration screen, which controls the underlying Create Collaboration Module 1122, which sets parameters such as time, duration and membership for a specific collaboration and controls sub-functions such as delivering invitations, sending communications to collaborators, and managing pre-determined tags.

The User Content button in the Main Menu takes the user to the User Content screen, which controls the underlying User Content Library Module 1124 controlling the above referenced personalized library of existing Collaboration content.

The Ongoing Collaboration button in the Main Menu takes a user to a Collaboration screen, which controls the underlying Collaboration Management Module 1126, which controls collaborations that are about to begin or have already begun. The Collaboration screen includes controls for the Incremental Media Generation and Management Module, 1128 which is responsible for such functions as incremental media generation, tagging, editing and captioning. The Ongoing Collaboration screen also controls user input for customizing the resultant animation by controlling the underlying Animation Control and Display Module, 1130 which determines the ordering of frames to be rendered in the resultant collaborative animation and links to the Animation Engine 1144. The Collaboration screen also includes controls for the underlying Communication Module 1132, which is responsible for communication between and among collaborators such as, but not limited to text messages sent between collaborators, captions, tag input and Like and Dislike “voting”, the later of which could be used as dynamic metadata to influence the order of elements in the animation.

The Related Website button in the Main Menu takes a user to a customized landing page on a related website curated in part by the Related Website Management Module 1134, which also generates in-app notifications about relevant content and comments generated on the related website and otherwise serves as an interface between the app and the website.

The Invite Others button takes the user to a Sharing and Invitations screen, which controls the Sharing and Invitations Module 1136, which allows users to invite others to download the app without inviting them to a specific collaboration; invites others to view specific collaborations on the website; and allows them to share the resultant collaborative animation with external social networks.

Also shown in FIG. 11 is the media management system 1140 which includes several components to facilitate the transformation of still images (including series of stop motion or brief sequential video frames) into animation-ready images and associated metadata. The components include a data and Metadata Management module 1142, a checksum module 1144, an image sizing module 1146, and an Animation Engine. Different components and configurations may be provided for different platforms, with Windows, iOS and Android, for example, each requiring customization of the configurations.

In some embodiments, the data and metadata management module 1142 facilitates the uploading and downloading of content data, incremental and collaborative, from individual devices to servers and controls the associated metadata needed by the Animation Engine 1148. This data and metadata management module 1142 of some embodiments works between the UI and the Animation Engine to organize the incremental elements and make them available to the Animation Engine as it renders the animation requested by the UI. This data and metadata management module includes file name analysis to decode and parse and organize metadata encoded in the file name, such as but not limited to identifying the generating device, sequential image information time stamps or any other information other modules, input drivers or any other functions have stored in the file name, and make the information available to other modules and the animation engine, or to act upon the information.

The checksum generator 1144 runs an image file through a computation algorithm that generates a checksum of that image file, which is a hash of the image's content. The collaborative animation tools and the server may reference an image using an ID (e.g., unique key) for identifying the image and its metadata. The first key may be associated with a second key for accessing the image file that is stored at an external data source (e.g., a storage server). The second key may include or is a checksum of that one image file. This hash in some embodiments allows the image to be stored separately from its associated metadata.

While many of the features of the collaborative animation tools have been described as being performed by one module or by the Animation Engine, or described as being performed on the device or on a server, these processes and or portions of the processes might be performed elsewhere in the software or hardware architecture in various embodiments.

Some embodiments may include tools for real-time communication between and among participants. Examples include but are not limited to text and voice messages and would be available from the time the first user creates the event, throughout the event and after. These communications may be in-animation, so they are visible or audible only when the resultant animation is viewed or otherwise displayed; They may be in-Collaboration, visible or audible only during the collaboration; They may be in real time or asynchronous and audible or visible without regard to the status of the collaboration.

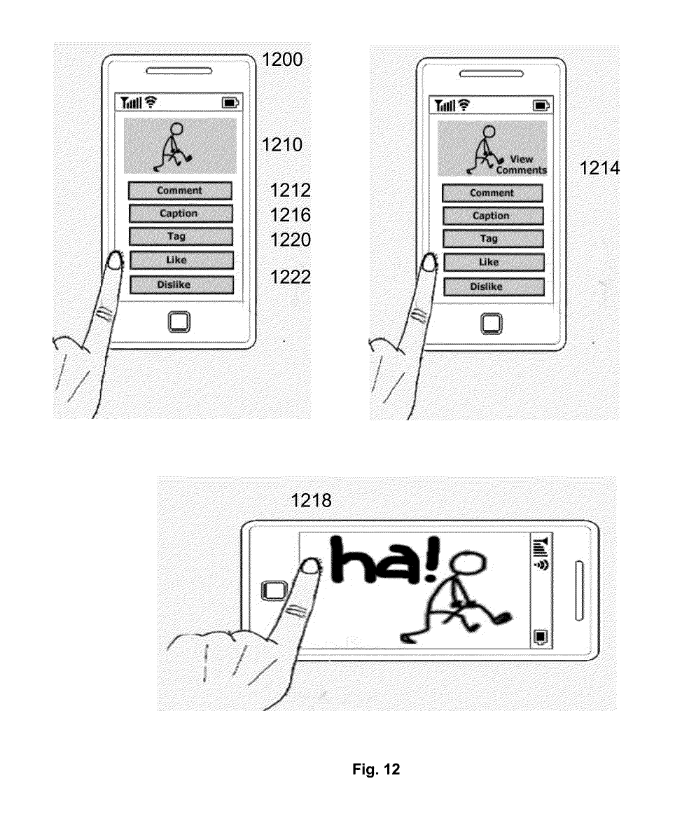

FIG. 12 shows one embodiment of the UI menu for these communications 1200. The UI includes a display area at the top 1210 in which the incremental elements are displayed as static images which may be scrolled using the touch screen. Beneath the display area are five buttons of optional sample of communication functions. The Comment Button 1212 allows collaborators to send comments to other collaborators, jointly or individually, with a number of delivery options, the comment can also be appended to the images for later viewing or listening when the animation is viewed in Communications mode by clicking on a View Comments link 1214. The UI offers to caption images using the Caption Button 1216. Captions differ from comments in that they are intended for display during the playing of the animation. They may be typed using the keyboard or hand lettered as an overlay using the touchscreen 1218. The app allows the First User to set permission levels, so that for example users are only allowed to caption their own images, or only certain collaborators are permitted to write captions. In some embodiments, captions may be set to be visible or audible to select collaborators, so that Collaborator A would see a wholly or partially different set of captions from Collaborator B. The Tag button 1220 allows all collaborators, or permitted collaborators, to add tags to any incremental elements in the collaboration. The tags become part of the metadata for an incremental element as described above. The Like and Dislike buttons 1222 are a subcategory of comments. A list of collaborators who like or dislike an incremental element similar to the Vice Comments link 1214 above. The Like and Dislike feedback can also be used by the animation engine to modify display order or determine whether to include individual frames in some embodiments.

What is claimed is:

1. A method for producing multi-author animation using metadata comprising:
a. providing a network;
b. providing at least one processor on the network;
c. providing a plurality of digital media devices capable of connecting to said network;
d. providing a camera on each of the plurality of media devices;
e. providing a user interface on each of the plurality of media devices that enables a human author to operate said camera to record digital photographs;
f. moving said digital photographs and from said two or more media devices to mutually accessible memory;
g. rendering the frames as an accretive digital animation according to the order of basic metadata such as simple file names, chronological file storage information or a random list of files;
h. exporting the rendered digital animation file, whereby the plurality of digital photographs recording the various perspectives of multiple authors has been co-mingled and transformed into a collaborative digital animation file;

2. A method for producing multi-author animation using metadata comprising:
a. providing a network;
b. providing at least one processor on the network;
c. providing a plurality of digital media devices capable of connecting to said network;
d. providing a camera on each of the plurality of media devices;
e. providing a user interface on each of the plurality of media devices that enables a human author to operate said camera to record digital photographs;
f. providing at least one auxiliary component on each of said media devices capable of generating information that can be recorded as metadata associated with said digital photographs;
g. providing an organizational system that facilitates structured storage and management of said digital photographs and said associated metadata;
h. moving said digital photographs and said associated metadata from said two or more media devices to mutually accessible memory;
i. providing a criteria for sorting the metadata;
j. sorting the metadata according to said criteria;
k. ordering the plurality of said digital photographs as incremental frames to reflect the order of the sorted metadata;
l. rendering the ordered frames as an accretive digital animation;
m. exporting the rendered digital animation file, whereby the plurality of digital photographs recording the various perspectives of multiple authors has been co-mingled, organized and transformed into a collaborative digital animation file;

3. Incorporating all of claim 2 further providing for human operators to add and manage metadata associated with the plurality of digital images;
a. providing one or more of the user interfaces on said media devices to enable a human operator to input information tags that can be recorded as metadata associated with said digital photographs;
b. providing one or more of the user interfaces on said media device to allow one or more of said human operators to select the criteria for sorting the metadata which supercedes the provided criteria.

4. Incorporating all of claim 2 further providing incremental time-lapse elements for the animation comprising:
a. providing a user interface on one or more of said media devices to enable a human operator to record a series of two or more still-image digital photographs separated by one or more time intervals;
b. providing metadata to mark the two or more still images of the time lapse series as a contiguous media element;
c. providing instructions to the organizational system to order the still images of the time lapse series as contiguous frames in the animation.

5. Incorporating all of claim 2 further providing decremental time-lapse elements for the animation comprising:
a. providing video capture on one or more of said media devices;
b. providing a user interface on one or more of said media devices to enable a human operator to record brief video sequences in which a plurality of frames equal to or greater than three frames is recorded;
c. reducing the number of frames from said video sequence to create a series of two or more frames separated by one or more time intervals;
d. providing metadata to mark the two or more frames of the time lapse series as contiguous frames;
e. providing instructions to the organizational system of claim 1 requiring it to order the images of the decremental time lapse element as contiguous frames in the animation.

6. Incorporating all of claim 2 further providing A method for producing multi-author audio using metadata comprising:
a. providing two or more network-capable media devices;
b. providing two or more microphones on said media devices;
c. providing a user interface on one or more of said media devices to enable a human operator to record one or more audio clips;
d. providing the recording of metadata about, and linked to, each one of the one or more audio clips;
e. moving and/or storing the audio clips and the associated metadata from the two or more media devices.
f. providing an organizational system that facilitates sorting, selecting, prioritizing and otherwise processing the metadata and from the two or more media devices;
g. providing a default sort of the metadata;
h. converting and outputting the plurality of audio clips from the two or more media devices into a sound track, with the ordering or prioritizing of the audio clips reflecting the ordering of the metadata.
